(19) United States
(12) Patent Application Publication
(10) Pub. No.: US 2012/0011414 A1
(43) Pub. Date: Jan. 12, 2012

(54) NETWORK MANAGEMENT SYSTEM, MANAGEMENT APPARATUS, MANAGED APPARATUS, AND NETWORK MANAGEMENT METHOD

(75) Inventor: Kenji NITTA, Kawasaki (JP)

(73) Assignee: FUJITSU LIMITED, Kawasaki (JP)

(21) Appl. No.: 13/176,801

(22) Filed: Jul. 6, 2011

(30) Foreign Application Priority Data
Jul. 7, 2010 (JP) 2010-154918

(51) Int. Cl. H04L 1/18; G06F 11/14

(52) U.S. Cl. 714/748; 714/E11.113

(57) ABSTRACT

A network management system includes a management apparatus and a managed apparatus which is managed by the management apparatus via a network. The managed apparatus transmits trap information provided with a sequence number to the management apparatus and stores the trap information in a first storage unit. The management apparatus stores the received trap information in a second storage unit, and creates information indicating a missing sequence number and a sequence number of a last trap information received from the managed apparatus, and transmits the information to the corresponding managed apparatus. The managed apparatus determines whether trap information is to be retransmitted is present based on the trap information stored in the first storage unit and the information received from the management apparatus, and retransmits the trap information, based on the determination.

### CROSS-REFERENCE TO RELATED APPLICATIONS

This application is based upon and claims the benefit of priority of the prior Japanese Patent Application No. 2010-154918, filed on Jul. 7, 2010, the entire contents of which are incorporated herein by reference.

### FIELD

The embodiments discussed herein are related to a network management system in which a management apparatus and a managed apparatus managed by the management apparatus are connected to a network.

### BACKGROUND

Generally, Simple Network Management Protocol (SNMP) has been widely used for management systems on server systems, network systems, and so on. A network management system with the SNMP includes a managed apparatus and a management apparatus which are connected together through the network. When an event is generated in the managed apparatus, an SNMP trap is transmitted as event information from the managed apparatus to the management apparatus to notify the management apparatus of the event.

The SNMP trap is transmitted in communication mode with a user datagram protocol (UDP). However, no communication path is established in the UDP communication mode. Thus, the SNMP trap might be lost. In other words, the loss of an SNMP trap may make confirmation of the event notification from the managed apparatus by the management apparatus difficult. Therefore, a technology for preventing an SNMP trap from being lost has been considered.

FIG. 12 is an exemplary technology for preventing the omission of SNMP. In an example illustrated in FIG. 12, a management apparatus 20 and a managed apparatus 40 are connected together through a communication network 10. Here, the communication network 10 is a communication link, such as a local area network (LAN) or a wide area network (WAN).

In the example illustrated in FIG. 12, when the managed apparatus 40 transmits an SNMP trap to the management apparatus 20, the management apparatus makes a reply to the managed apparatus 40 to prevent the omission of the SNMP trap. Hereinafter, description will be made on the case where the loss of an SNMP trap transmitted on the communication network 10 occurs due to any reason when the SNMP trap is transferred from the managed apparatus 40 to the management apparatus 20.

The managed apparatus 40 waits a fixed time after transmission of an SNMP trap for a response from the management device 20. When there is no response from the management apparatus even after passing the fixed time, that is, the time limit is over, the managed apparatus 40 retransmits the same SNMP trap as one previously transmitted to the management apparatus 20. When the management device 20 receives the SNMP trap retransmitted from the managed apparatus 40, a trap response (SetRequest) which indicates the reception of the SNMP trap is transmitted to the managed apparatus 40. Then, the managed apparatus 40, which has received the trap response, sends a reply (GetResponse) to the trap response to the management apparatus 20, completing a series of trap transmission/reception procedures.

In the example illustrated in FIG. 12, therefore, omission of an SNMP trap is prevented by allowing the managed apparatus 40, which has transmitted the SNMP trap, to wait for a response from the management apparatus 20 for a fixed time and to retransmit the SNMP trap if there is no response within the fixed time.

FIG. 13 illustrates an exemplary technology for preventing the omission of an SNMP trap, which is different from the example illustrated in FIG. 12. The example illustrated in FIG. 13 provides trap information with a sequence number with every transmission of an SNM trap to allow the management apparatus 20 to make sure there is a missing sequence number. When there is a missing sequence number, the management apparatus 20 requests the managed apparatus 40 to retransmit the lost trap.

In the example illustrated in FIG. 13, it is assumed that an SNMP trap with sequence number 1 is lost on a communication network 10 when the managed apparatus 40 transmits two SNMP traps with sequence numbers 1 and 2. In this case, the management apparatus 20 receives the trap with sequence number 2 without receiving the trap with sequence number 1. Thus, it is found that the trap with sequence number 1 is omitted. Therefore, the management apparatus 20 outputs, to the managed apparatus 40, a request for retransmission of the trap with sequence number 1 to make the managed apparatus 40 retransmit the lost trap with sequence number 1.

According to the process described above, one trap is received and the omission of the trap previous to this trap is then detected. Therefore, when the last trap transmitted from the managed apparatus 40 is lost on the communication network 10 (for example, a trap with sequence number 3 in FIG. 13), the loss of the final trap would not be detected.

As a method for overcoming this disadvantage, when a fixed time passes from the time when the management apparatus 20 receives the final trap, the management apparatus 20 asks the managed apparatus 40 about the sequence number of the final trap received by the managed apparatus 40. Then, when the sequence number of the last trap received by the management apparatus 20 does not match the sequence number of the last trap transmitted from the managed apparatus 40, the management apparatus 20 requests the managed apparatus 40 to retransmit the final trap which has been lost.

The related patent documents include: Japanese Laid-open Patent Publication No. 08-331206; Japanese Laid-open Patent Publication No. 09-247146; Japanese Laid-open Patent Publication No. 2003-244142; and Japanese Laid-open Patent Publication No. 2001-160013.

As described above, according to the typical technology, the confirmation and response for the transmission/reception of a trap are performed through the communication network 10 every time the trap is transmitted between the management apparatus 20 and the managed apparatus 40. However, in a situation where the omission of a trap occurs, congestion may often occur in the communication network 10. In this case, the typical technology as described above has a disadvantage in that the congestion state of the communication network 10 further deteriorates to cause further omission of traps because transmission of a trap response, a request for retransmission, or the like is performed for every trap transmission.

Furthermore, if the number of management apparatuses increases to several hundred or several thousand, there is a disadvantage in that a heavy load is placed on the management apparatus 20 and processing may not catch up with the load by the process where the management device 20 performs transmission of a trap response, a request for retransmission, or the like for every trap transmission.

Therefore, it is desirable to provide a solution to problems existing in the typical technology including preventing the trap number from being omitted while preventing the communication network 10 from being loaded more than necessary and reducing the amount of a processing load on the management apparatus 20.

### SUMMARY

A network management system includes a management apparatus which is connected to a network and a managed apparatus which is connected to the network and is managed by the management apparatus. The managed apparatus includes a first transmitting unit to transmit trap information provided with a sequence number to the management apparatus and a first storage unit to store the trap information.

According to an aspect the management apparatus includes a second storage unit to store the trap information received from the managed apparatus, a processing unit to create information indicating a missing sequence number and a sequence number of a last trap information received from the managed apparatus, and a second transmitting unit to transmit the information to the corresponding managed apparatus. The managed apparatus further includes a trap-list processing unit to determine whether trap information is to be retransmitted based on the trap information stored in the first storage unit and the information received from the management apparatus, and retransmit the trap information to the management apparatus.

Objects and advantages of the invention will be realized and attained by means of the elements and combinations particularly pointed out in the claims.

It is to be understood that both the foregoing general description and the following detailed description are exemplary and explanatory and are not restrictive of the invention, as claimed.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a diagram illustrating an exemplary configuration of a network management system according to an embodiment;

FIG. 2 is a diagram illustrating an exemplary configuration of a management apparatus according to an embodiment;

FIG. 3 is a diagram illustrating an exemplary configuration of a managed apparatus according to an embodiment;

FIG. 4 is a diagram illustrating an exemplary retransmission sequence of an SNMP trap according to an embodiment;

FIG. 5 is a diagram illustrating an exemplary process flow for transmitting an SNMP trap from a managed apparatus to a management apparatus according to an embodiment;

FIG. 6 is a diagram illustrating an exemplary process flow for transmitting and receiving an SNMP trap list and retransmitting an SNMP trap according to an embodiment;

FIG. 7 is a diagram illustrating an exemplary process flow for transmitting an SNMP trap by a managed apparatus;

FIG. 8 is a diagram illustrating an exemplary process flow for receiving an SNMP trap by a management apparatus;

FIG. 9 is a diagram illustrating an exemplary process flow from an operation of making a trap list to an operation of transmitting the trap list by a management apparatus;

FIG. 10 is a diagram illustrating the rest of the flow illustrated in FIG. 9;

FIG. 11 is a diagram illustrating an exemplary process flow from an operation of receiving a trap list to an operation of retransmitting an SNMP trap by a managed apparatus;

FIG. 12 is a diagram illustrating an exemplary technology for preventing an SNMP trap from being omitted; and

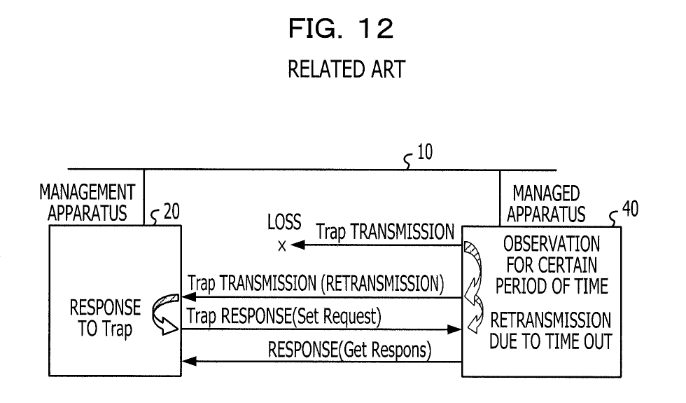

FIG. 13 is a diagram illustrating an exemplary technology for preventing an SNMP trap from being omitted.

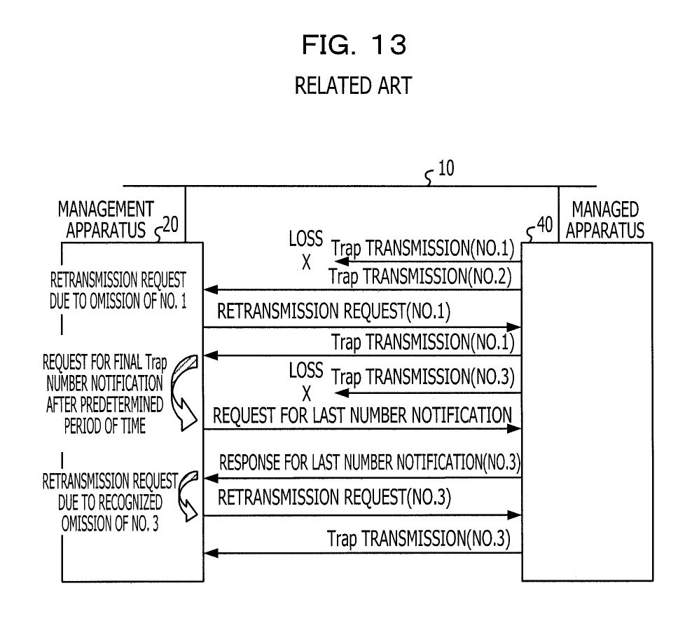

### DETAILED DESCRIPTION

Reference will now be made in detail to the embodiments, examples of which are illustrated in the accompanying drawings, wherein like reference numerals refer to the like elements throughout. The embodiments are described below to explain the present invention by referring to the figures.

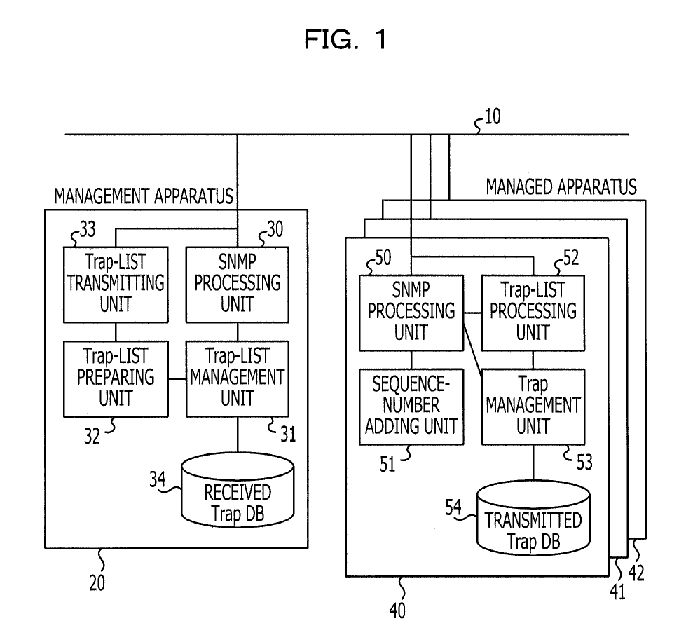

FIG. 1 is a diagram illustrating an exemplary configuration of a network management system according to an embodiment. In the exemplary configuration of the system illustrated in FIG. 1, a management apparatus 20 is connected to a plurality of managed apparatuses 40 to 42 through a communication network 10. In this figure, three managed apparatuses 40 to 42 (40, 41 and 42) are illustrated. However, the number of the managed apparatuses is not limited to three.

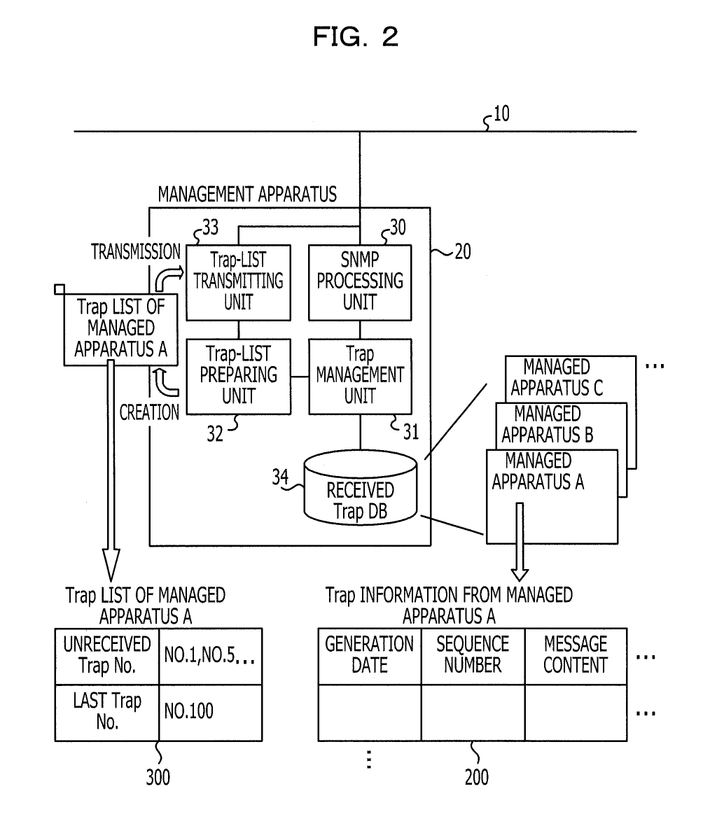

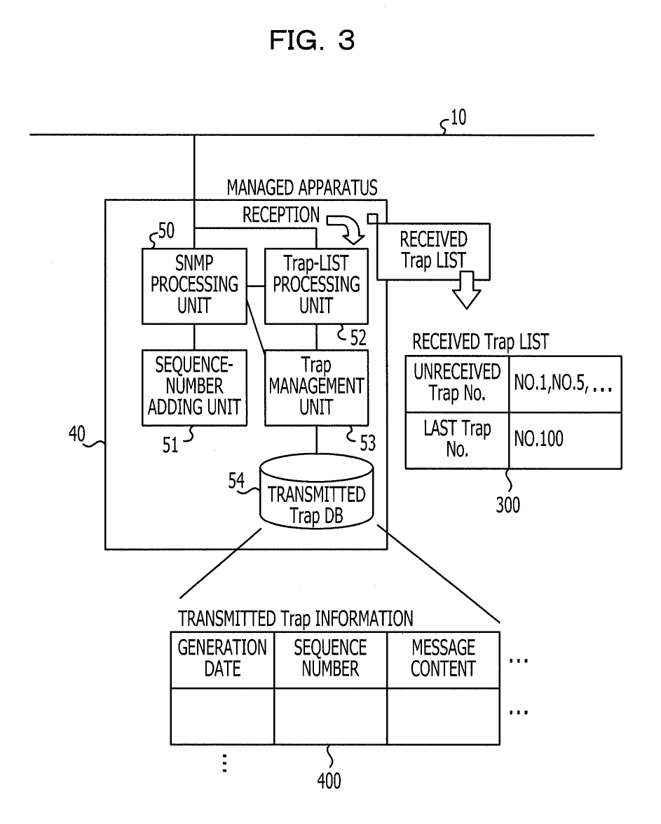

As illustrated in FIG. 1, the management apparatus 20 includes an SNMP processing unit 30, a trap-list management unit 31, a trap-list preparing unit 32, a trap-list transmitting unit 33, and a received trap database (DB) 34. The managed apparatus 40 includes an SNMP processing unit 50, a sequence-number adding unit 51, a trap-list processing unit 52, a trap management unit 53, and a transmitted trap database (DB) 54. In the following description, an exemplary configuration of the management apparatus of the embodiment will be described with reference to FIG. 2. In addition, an exemplary configuration of the managed apparatus of the embodiment will be described with reference to FIG. 3.

FIG. 2 is a diagram illustrating an exemplary configuration of a management apparatus according to an embodiment. The management apparatus 20 is provided for managing managed apparatuses connected to the communication network 10. As mentioned above, the management apparatus 20 includes the SNMP processing unit 30, the trap-list management unit 31, the trap-list preparing unit 32, the trap-list transmitting unit 33, and the received trap DB 34.

The received trap DB 34 is provided for storing a trap received from the managed apparatus for every managed apparatus. The received trap DB 34 stores trap information 200 including the generation date, a sequence number, message content, and the like of a trap transmitted to each of the managed apparatuses 40 to 42. Furthermore, in addition to these pieces of information, the time at which the trap is received from each managed apparatus may be stored in the received trap DB 34 in addition to the storage of the times at which the traps are received from the respective managed apparatuses. While specific examples of the trap information received from a managed apparatus is provided herein, the present invention is not limited to any particular information. For example, the received trap DB 34 may contain any data that uniquely identifies any of the managed apparatuses 40 to 42 with respect to corresponding trap information received therefrom.

The SNMP processing unit 30 performs each process for receiving or transmitting an SNMP trap. The trap-list management unit 31 stores a trap received from the managed apparatus in the received trap DB 34, reads out the trap from the received trap DB 34, searches trap information stored in the received trap DB 34, and so on.

The trap-list preparing unit 32 creates a trap list 300 which is a list about the trap information stored in the received trap DB 34 for every fixed period of time. Here, the trap list 300 records the sequence number of a trap which has not been received by the management device 20 within a fixed period of time, or the number corresponding to the omitted trap sequence number of the received trap. In addition, the sequence number of the last received trap is also recorded in the trap list 300. The trap-list transmitting unit 33 transmits the trap list created by the trap-list creating unit 32 to the managed apparatus.

As illustrated in FIG. 3, the managed apparatus 40 includes the SNMP processing unit 50, the sequence-number adding unit 51, the trap-list processing unit 52, the trap management unit 53, and the transmitted trap DB 54. The configurations of the respective managed apparatuses are similar to one another, so that the configuration of the managed apparatus 40 will be described as a representative of the respective managed apparatuses.

The transmitted trap DB 54 is provided for storing transmitted trap information 400 which is information about an SNMP trap transmitted to the management apparatus. The transmitted trap DB 54 stores trap information 400 including the generation date, the sequence number, message content, and the like of a trap transmitted to the management apparatus. As mentioned above, while specific examples are provided herein, the present invention is not limited to any particular information. For example, the transmitted trap information may also contain any data that uniquely identifies any of the managed apparatuses 40 to 42 with respect to corresponding trap information, time information, etc.

The SNMP processing unit 50 performs each process for transmitting or receiving the SNMP trap. The sequence-number adding unit 51 adds a consecutive sequence number to an SNMP trap to be transmitted to the management apparatus 20. The trap management unit 53 stores the trap transmitted to the management apparatus 20 in the transmitted trap DB 54, reads the trap from the transmitted trap DB 54, and searches track information stored in the transmitted trap DB 54.

The trap-list processing unit 52 determines whether there is a trap to be retransmitted because of trap omission with reference to the trap list 300 received from the management apparatus 20, and then instructs the SNMP processing unit 50 to retransmit the trap.

In the network management system having the configuration illustrated in FIG. 1 to FIG. 3 (FIG. 1, FIG. 2 and FIG. 3), at regular time intervals, the management apparatus 20 allows the trap-list creating unit 32 to create the trap list 300 for each managed apparatus and then transmits the created trap list 300 to the corresponding managed apparatus. The trap list 300 created for each managed apparatus includes information about the sequence number of a trap which is not received by the management apparatus 20 within a predetermined period and the sequence number of a trap which is received last from the managed apparatus. In each of the managed apparatuses 40 to 42, the trap-list processing unit 52 determines whether there is a trap to be transmitted to the management apparatus on the basis of information of the trap list 300 received from the management apparatus and the information stored in the transmitted trap DB 54. Furthermore, each of the managed apparatuses 40 to 42 retransmits a trap to be retransmitted to the management apparatus 20.

By employing this system, it becomes possible to eliminate the need of a response for SNMP trap reception between the management apparatus and the managed apparatus, which is performed for every SNMP trap transmission, request/response to a notification of the sequence number of the final trap, and the like, which would have been performed by the typical technology. In other words, the network management system illustrated in FIG. 1 to FIG. 3 may reduce the load on the communication network 10. Furthermore, in the typical technology, the need of retransmitting an SNMP trap has been determined by the management apparatus. In this embodiment, each managed apparatus is responsible for making this determination to allow for reducing the load of the management apparatus when the number of managed apparatuses increases.

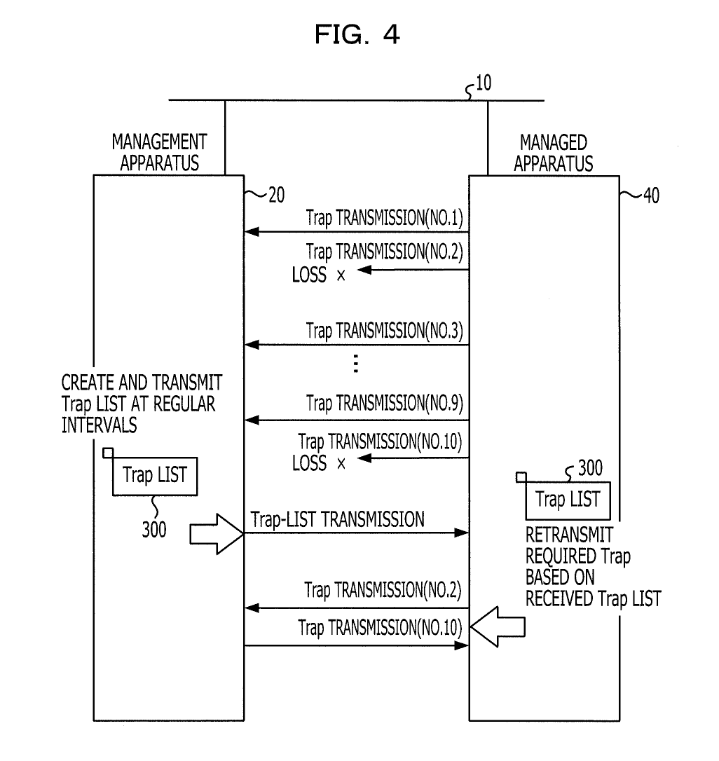

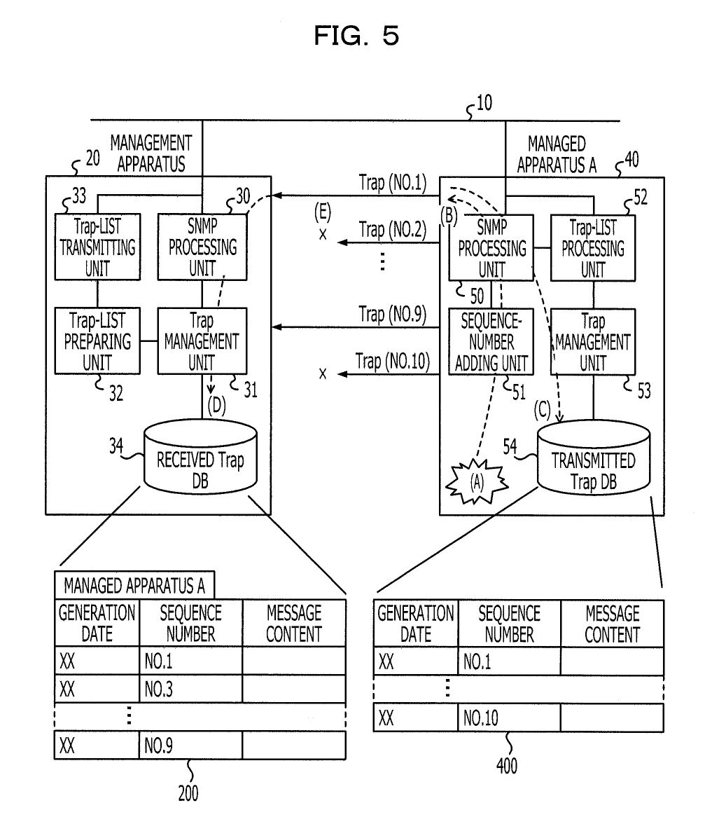

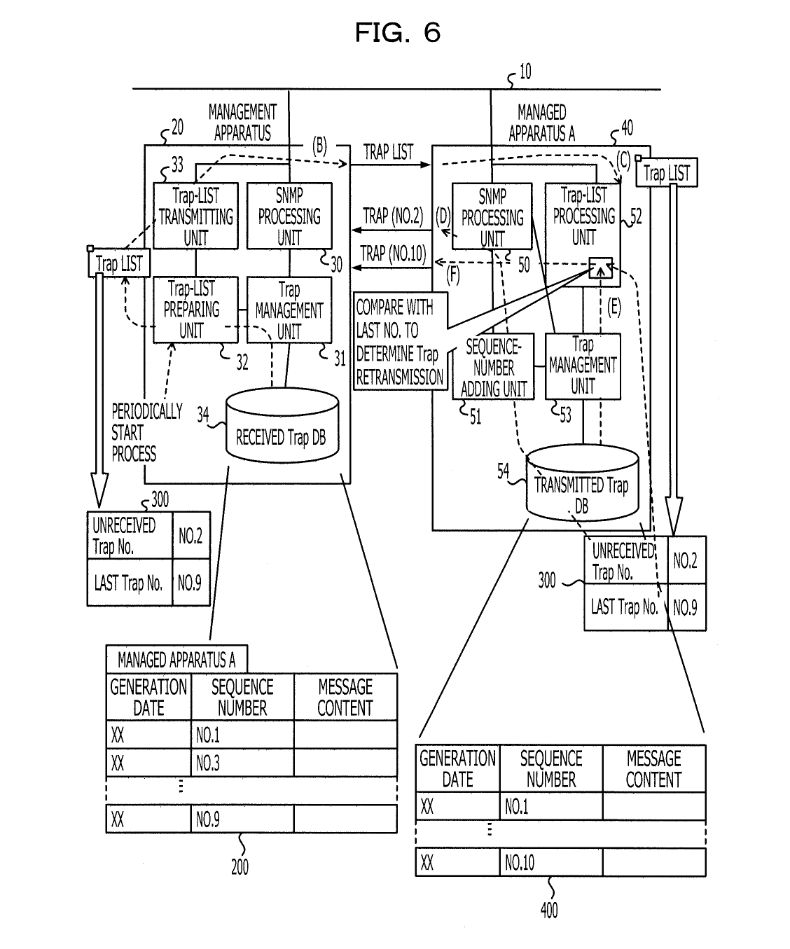

Hereinafter, an exemplary retransmission sequence of the SNMP trap according to an embodiment is illustrated in FIG. 4. In addition, a process performed in the managed apparatus 40 and the management apparatus 20 in this example will be described with reference to FIG. 5 and FIG. 6.

FIG. 4 is a diagram illustrating an exemplary retransmission sequence of an SNMP trap according to an embodiment. Specifically, FIG. 4 illustrates an example in which an SNMP trap with sequence number 2 and an SNMP trap with sequence number 10 are lost on the communication network when ten SNMP traps with sequence numbers from 1 to 10 are transmitted from the managed apparatus 40 to the management apparatus 20.

It is assumed that the managed apparatus 40 transmits SNMP traps with sequence numbers from 1 to 10. Then, the management apparatus 20 creates a trap list 300 for the managed apparatus 40 at a certain time after passing a predetermined time from creating a trap list 300 for the managed apparatus 40 at the previous time. The management apparatus 20 creates a trap list 300 based on the information about an SNMP trap received from the managed apparatus 40 after the time of creating the last trap list 300 and then transmits the new trap list 300 to the managed apparatus 400. The managed apparatus 40 confirms the content of the trap list 300 transmitted from the management apparatus 20. When the managed apparatus 40 recognizes that the SNMP traps with sequences numbers 2 and 10 have not arrived, the managed apparatus 40 retransmits these not-yet-received SNMP traps to the management apparatus 20.

FIG. 5 illustrates a process flow for transmitting an SNMP trap from the managed apparatus 40 to the management apparatus 20 and a process flow for receiving the SNMP trap by the management apparatus 20 in the example illustrated in FIG. 4.

In the managed apparatus 40, a trap transmission factor or event may occur due to a certain error, a control operation, such as a hardware reset, a change in status of the apparatus, or the like. When the trap transmission factor has occurred in the managed apparatus 4 ((A) in FIG. 5), the sequence-number adding unit 41 adds a series of sequence numbers to traps generated in response to the generated factor. The traps provided with sequence numbers by the sequence-number adding unit 51 are transmitted to the management apparatus 20 by the SNMP processing unit 50 ((B) in FIG. 5). Furthermore, the trap transmitted to the management apparatus 20 by the SNMP processing unit 50 is stored in the transmission trap DB 54 of the managed apparatus 40 ((C) in FIG. 5).

In the management apparatus 20, the SNMP processing unit 30 receives the SNMP trap transmitted from the managed apparatus 40. The trap-list management unit 31 stores the trap received from the managed apparatus 40 in the received trap DB 34 for every managed apparatus ((D) in FIG. 5).

Thus, information of traps for every managed apparatus is recorded on the transmitted trap DB 54 of the managed apparatus 40 and the received trap DB 34 of the management apparatus 20, successively. However, when the SNMP trap transmitted from the managed apparatus 40 does not reach the management apparatus 20 due to the congestion of the communication network 10, the corresponding trap information is not recorded in the received trap DB 34 of the management apparatus 20 (“Trap (No. 2)” of (E) in FIG. 5).

FIG. 6 is a diagram illustrating a process flow for creating and transmitting a trap list 300 by the management apparatus 20 and receiving the trap list 300 and resending the trap by the managed apparatus 40.

The management apparatus 20 executes a process for creating a trap list periodically, for example, every hour. When the trap-list preparing process is started, the trap-list creating unit 32 searches the received trap DB 34 through the trap-list management unit 31 to determine and extract an unreceived trap among traps received within a fixed time (in this example, within one hour), or a trap with an omitted sequence number. Furthermore, the trap-list creating unit 32 extracts the sequence number of the last trap received from the managed apparatus 40. Then, a trap list 300 is prepared from the information of the extracted sequence numbers ((A) in FIG. 6). In the example illustrated in FIG. 6, the trap-list creating unit 32 records the unreceived trap number 2 (No. 2) and the last trap number 9 (No. 9) on the trap list 300 in the state where the managed apparatus 40 is transmitting the traps with sequence numbers up to 10 (No. 10). The trap-list transmitting unit 33 transmits the created trap list 300 to the corresponding managed apparatus (in this example, the managed apparatus 40) ((B) in FIG. 6).

In the managed apparatus 40, the trap-list processing unit 52 receives the trap list 300 ((C) in FIG. 6). If there is a trap which is not received by the management apparatus 20, the sequence number of the unreceived trap is written in the received trap list 300. Thus, when the sequence number 2 is written in the column of the unreceived trap number in the trap list 300, the trap-list processing unit 52 instructs the SNMP processing unit 50 to retransmit the trap with sequence number 2 ((C) in FIG. 6). Then, the unreceived trap No. 2 is retransmitted to the management apparatus 20 ((D) in FIG. 6).

In addition, the trap-list processing unit 52 acquires the sequence number of the last trap, which is transmitted from the transmitted trap DB 54 by the managed apparatus 40 through the trap management unit 53 ((E) in FIG. 6). Then the trap-list processing unit 52 makes a comparison between the sequence number of the transmitted last trap acquired from the transmission trap DB 54 and the sequence number of the last trap included in the trap list 300 received from the management apparatus 20. As a result of comparing these sequence numbers, when the sequence number of the last trap in the trap list 300 is smaller than that of the transmitted last trap acquired from the transmission trap DB 54, the trap-list processing unit 52 instructs the SNMP processing unit 50 to retransmit the traps with sequence numbers from “the sequence number of the last trap in the trap list 300+1” to “the sequence number of the last trap transmitted to the management apparatus 20” to perform a retransmission process ((F) in FIG. 6). In FIG, 6, the targets of the retransmission process are the number obtained by adding 1 to the sequence number of the last trap of the trap list 300 (No. 9+1) and the number of the last trap transmitted by the managed apparatus 40 (No. 10).

When the aforementioned management apparatus 20 creates a trap list 300 periodically, an SNMP trap may be transmitted from the managed apparatus 40 during or immediately after the creation of the trap list by the management apparatus 40. In this case, the sequence number of the last SNMP trap transmitted from the managed apparatus 40 may be reflected as the last trap number in the trap list 300. Therefore, the last trap number recorded in the trap list 300 does not match the sequence number of the last trap transmitted by the managed apparatus 40 when the managed apparatus 40 receives the trap list 300. Thus, the managed apparatus 40 retransmits the last trap. In other words, two traps, which have the same content as that of the last trap transmitted by the managed apparatus 40, are transmitted to the management apparatus.

In particular, however, there is no problem because any trap transmitted from the managed apparatus 40 is not lost even if the management apparatus 20 receives two traps with identical contents. When the management apparatus 20 receives two traps with identical contents, for example, the management apparatus 20 may delete the first received trap or may keep two traps in the received trap DB 34 to use one of them.

Furthermore, if the aforementioned management apparatus 20 creates a trap list 300 periodically and transmits the trap list 300 using a UDP communication mode in a manner similar to the transmission of an SNMP trap, there is a possibility of losing the trap list 300 on the communication network 10. In the case where the trap list 300 transmitted from the management apparatus 20 is lost on the communication network 10 and does not reach the managed apparatus 40, even if an SNMP trap transmitted from the managed apparatus is omitted, the managed apparatus may not be able to detect this lost trap list. Therefore, the trap list 300, which is transmitted from the management apparatus 20 to the managed apparatus 40, may be transmitted using a protocol, such as a transmission control protocol (TCP), which may ensure the transmission. The use of TCP allows the management apparatus 20 to perform a confirmation response and retransmission for reliably transmitting the transmission data, so that reliable transmission of a trap list 300 may become possible. In contrast, in the case where the trap list 300 is transmitted using a UDP communication mode without the use of TCP, a confirmation response and retransmission for confirming whether the managed apparatus 40 receives the trap list 300 transmitted from the management apparatus 20 may be performed (not shown).

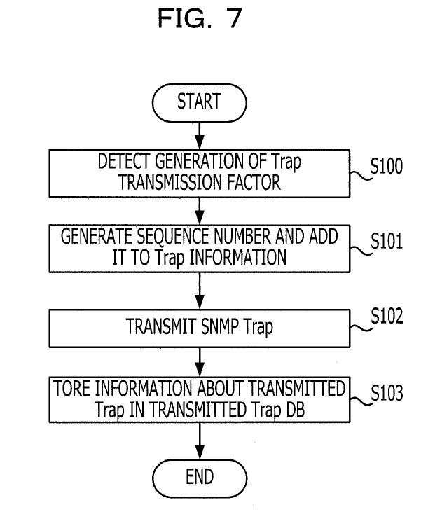

Hereinafter, flows of the respective processes in the managed apparatus 40 and the management apparatus 20 will be described with reference to FIG. 7 to FIG. 11, respectively.

FIG. 7 is an exemplary process flow for transmitting an SNMP trap in the managed apparatus 40. When the managed apparatus 40 detects the generation of a trap transmission factor (event) due to any factor in the apparatus (S100), the sequence-number adding unit 51 provides a trap generated in response to the caused factor with a sequence number (S101). Then, the SNMP processing unit 50 of the managed apparatus 40 transmits the SNMP trap with the sequence number to the management apparatus 20 (S102), followed by storing the information of the transmitted SNMP trap (such as generation date, sequence number, and message content) in the transmission trap DB 54 through the trap management unit 53 (S103).

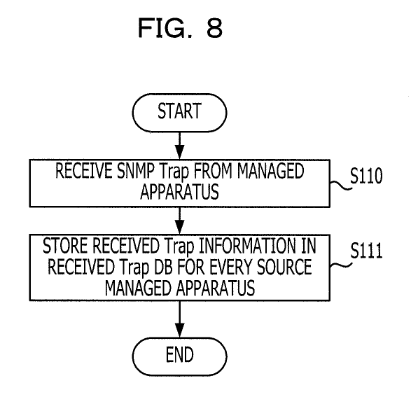

FIG. 8 is a diagram illustrating an exemplary process flow for receiving an SNMP trap by the managed apparatus 20. When the management device 20 receives the SNMP trap retransmitted from the managed apparatus 40 (S110), the received trap is stored in the received trap DB 34 for every source managed apparatus (S111). The received trap is stored across data applicable for each source managed apparatus.

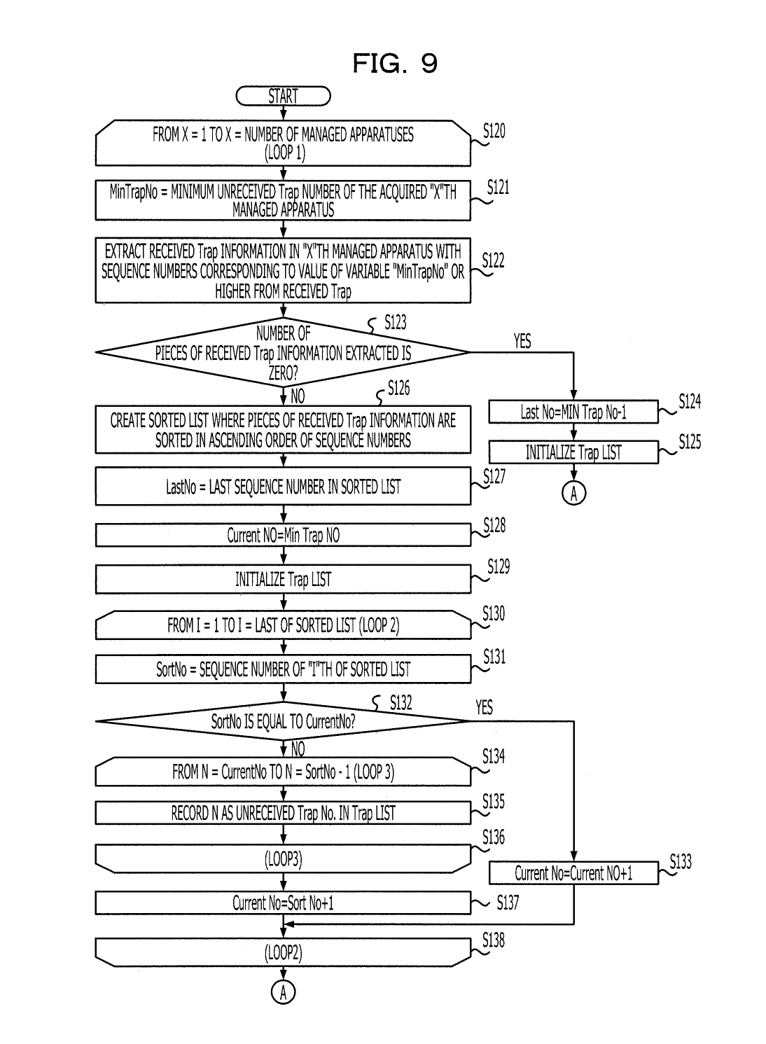

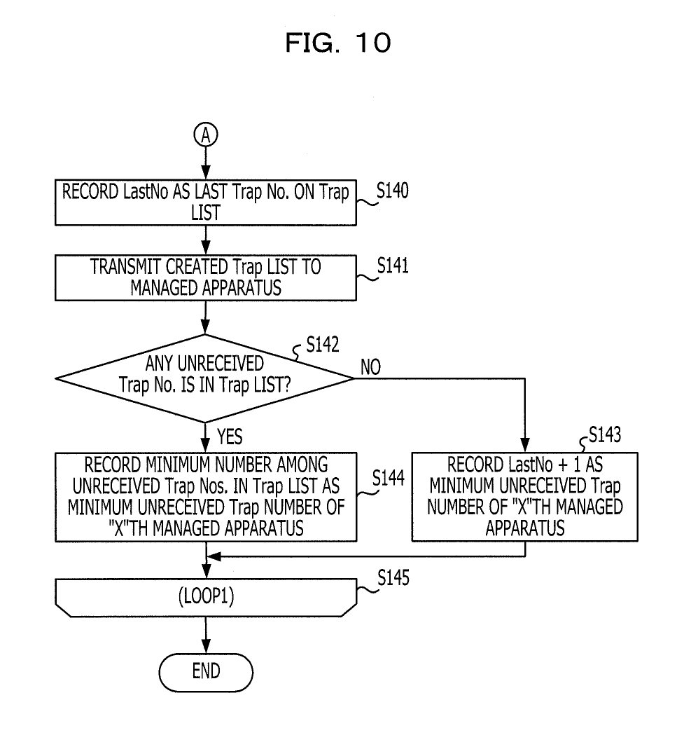

FIG. 9 and FIG. 10 are diagrams illustrating two divided parts of an exemplary process flow from an operation of creating a trap list 300 to an operation of transmitting the trap list by the management apparatus 20. The portion “A” in FIG. 9 corresponds to the portion “A” in FIG. 10, representing the same in the flows.

The management apparatus 20 creates a trap list 300 for every managed apparatus, which is represented in the exemplary flow illustrated in FIG. 9 and FIG. 10. Specifically, in loop 1 surrounded by S120 (FIG. 9) and S145 (FIG. 10) at the beginning, the management apparatus 20 sets a value of the loop variable “X”, which is a positive integer, on each of managed apparatuses to provide them with serial numbers in order of 1 to the total number of the managed apparatuses, followed by sequentially selecting the managed apparatuses.

When specific value is set to the loop variable “X” to select the managed apparatus, the minimum number among the sequence numbers of unreceived traps corresponding to the selected managed apparatus, the “unreceived minimum trap number”, is acquired from the information stored in the received trap DB 34. Then, the minimum unreceived trap number of the acquired “X”th managed apparatus is set to the variable “MinTrapNo” (S121). Here, the variable “MinTrapNo” is the minimum sequence number among the sequence numbers of trap information stored in the received trap DB 34 to be used in the creation of a trap list 300.

The minimum unreceived trap number for each managed apparatus is initialized to a suitable value in advance. Here, the term “suitable value” means the sequence number of a trap to be next used by each managed apparatus when the management apparatus is initiated. In the case where the management apparatus and the managed apparatus are initiated simultaneously, the value is usually set to “1”. The minimum unreceived trap number may be stored for every managed apparatus in a predetermined area of the received trap DB 34 in FIG. 2 or may be stored in another specific storage, such as a memory or a register.

After setting the minimum unreceived trap number to the variable “MinTrapNo” (S121), the received trap information with the sequence numbers corresponding to the value of the variable “MinTrapNo” or higher is extracted from the received trap information stored in the received trap DB 34 (S122). If the number of pieces of the received trap information extracted in S122 is zero (YES in S123), or if no trap is received yet from the “X”th managed apparatus, the variable “LastNo” is set to a value of “MinTrapNo-1” (here, “0”) (S124). Here, the variable “LastNo” is the largest sequence number among the sequence numbers of trap information stored in the received trap DB 34 to be used in creation of a trap list 300. Then, the trap list 300 is initialized (S125) and the process proceeds to the operation S140 in FIG. 10.

When the number of pieces of the received trap information which is larger than the minimum unreceived trap number extracted in the operation S122 is not zero (NO in S123), or if there is a trap received from the “X”th managed apparatus, the process proceeds to the operation S126 and subsequent operations. A procedure in the operation S126 creates a sorted list where the pieces of the received trap information are sorted in ascending order of sequence numbers included in the received trap information extracted in the operation S122 (S126). The contents of the sorted list may be those obtained by extracting only information about the sequence numbers among the information contained in the received trap information, and sorting the extracted information in ascending order.

When the sorted list is created in the operation S126, the last sequence number in the sorted list is set to the variable “LastNo” (S127). Subsequently, the value of “MintrapNo” set up in the operation S121 is set to the variable “CurrentNo” (S128) and the contents of the trap list 300 are then initialized (S129). Here, the variable “CurrentNo” is a variable for confirming whether there is any omission in the sequence numbers in the sorted list created in the operation S126.

Next, in loop 2 surrounded by S130 and S138, the loop variable “i” is incremented from 1 to the last item of the sorted list, or to the number of sequence numbers, one by one in series, while procedures in the operations S131 to S137 are executed. The procedures in the operations S131 to S137 confirm whether any omission is found in a series of sequence numbers included in the sorted list created in the operation S126.

A procedure in the operation S131 increments the sequence number of the list located at the position counted from the first of the sorted list to the value of the loop variable “i”, or the increment of the number of loops in the operation 130 (S131). Then, it is determined whether the value of the sequence number, which is set in the operation S131, matches the value of the sequence number, which is set to the variable “CurrentNo” (S132). Here, when an omission occurs in the SNMP traps received from the managed apparatus, or when any SNMP trap is lost in the communication network 10 or the like, the comparison in the operation S132 results in a mismatch.

When the comparison results in the operation S132 indicate that the above values match each other (YES in S132), then the process proceeds to the operation S133 and the value of the variable “CurrentNo” is incremented by “1”. Then, the process proceeds to the end of loop 2, the operation S138, and then returns to the operation S130 to increment the loop variable “i” by “1” to confirm whether an omission of the next sequence number in the sorted list occurred.

If the comparison in the operation S132 results in a mismatch or in the presence of an unreceived trap (NO in S132), the process proceeds to the operation S134 and subsequent operations. In loop 3 surrounded by the operations S134 and S136, an unreceived trap sequence number, in other words a sequence number omitted from the sorted list, is recorded as an unreceived trap number in the trap list 300. Specifically, the loop variable “n” of loop 3 is incremented from “CurrentNo” to 2SortNo-1” (S134), while the value of variable “n” is added as an unreceived trap number to the trap list 300 (S135).

After adding the omitted sequence number to the trap list 300 (S134 to S136), “SortNo+1” is set to “CurrentNo” (S137) and the process returns to the beginning of loop 2 (S130) through the operation S138. Then, it is confirmed whether the subsequent sequence numbers of the present SortNo has an omission.

The process proceeds to the operation S140 in FIG. 10 after confirming whether an omitted sequence number is in all the sequence numbers in the sorted list in the operations S130 to S138. The operation S140 records variable “LastNo” in the trap list 300 as a sequence number of the last trap in the sorted list. When the procedure in the operation S140 is completed, the creation of a trap list 300 to be transmitted to the managed apparatus which is specified by the value of the loop variable “X”. Thus, the created trap list 300 is transferred to the managed apparatus specified by the value of the loop variable “X” (S141).

The reason for extracting the received trap information while going back to the sequence number of the minimum unreceived trap number in the operation S122 is to confirm whether the retransmitted trap information is correctly received when there is retransmitted trap information which has been retransmitted by the managed apparatus in the past. In other words, when there is a trap lost in the communication network 10 or the like among the traps transmitted from the managed apparatus, it is confirmed whether a lost trap is correctly retransmitted by the managed apparatus with reference to the trap list 300 transmitted from the management apparatus 20.

Therefore, when there is no unreceived trap number in the created trap list 300, the sequence number may set the “minimum unreceived trap number” to the sequence number corresponding to a trap to be received after this time. Specifically, if there is no unreceived trap number in the created trap list 300 (NO in S143), “LastNo+1” is recorded in a predetermined storage location, such as the received trap DB 34, as the minimum unreceived trap number of the “X”th managed apparatus (S143). In addition, when the unreceived trap number is present in the created trap list 300 (YES in S143), the minimum number among the unreceived trap numbers in the created trap list 300 is recorded in a predetermined storage location as the minimum unreceived trap number of the “X”th managed apparatus (S144). The minimum unreceived trap number recorded in the operation S143 or S144 is used as “MinTrapNo” in creation of the next trap list 300. By updating the unreceived trap number every time a trap list 300 is created as described above, the received trap information to be periodically investigated by the management apparatus 20 may be minimized to reduce a processing load on the management apparatus 20.

In the case where it is previously recognized that the number of traps to be received from the managed apparatus is not many, the process in the management apparatus 20 may be simplified by omitting the procedure for updating the minimum unreceived trap number in the operations S142 to S144 to keep the minimum unreceived trap number at the initial value.

When the minimum unreceived trap number is updated by the process in the operation S143 or S144, the creation and transmission of a trap list 300 for the “X”th managed apparatus are completed. Subsequently, the process returns to loop 1 in the operation S120 again through the operation S145 and the value of the loop variable “X” is incremented by “1” and the creation and transmission of a trap list 300 for the next managed apparatus. Furthermore, when the creation and transmission of trap lists 300 for all the managed apparatuses are completed, the series of processes in FIG. 9 and FIG. 10 are completed.

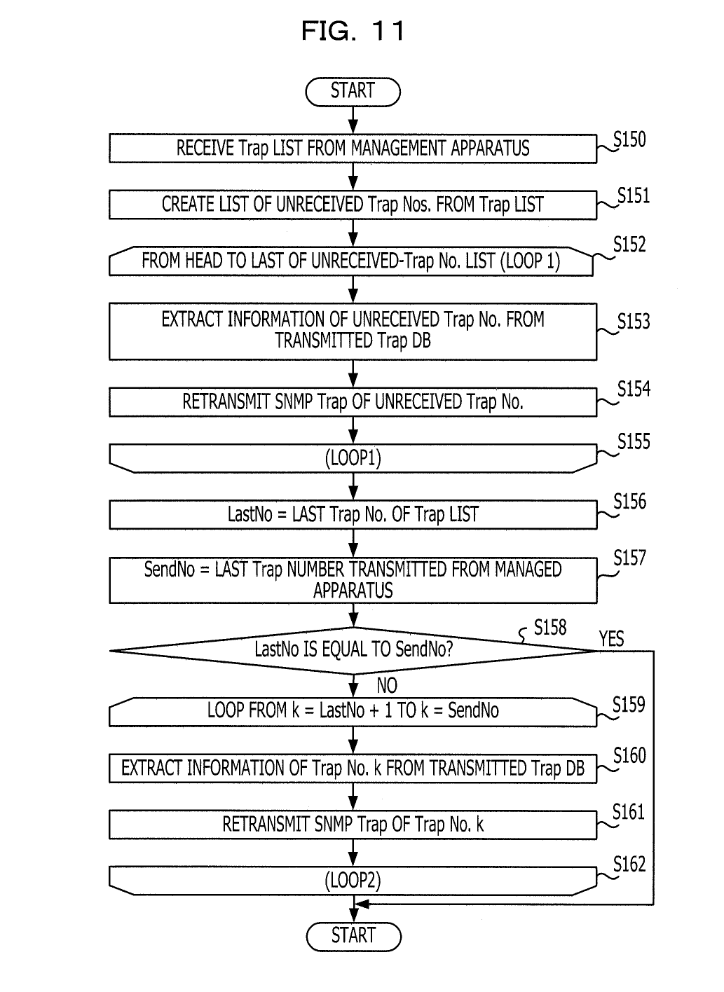

FIG. 11 is a diagram illustrating an exemplary process flow from an operation of receiving a trap list 300 to an operation of retransmitting an SNMP trap by the managed apparatus. That is, FIG. 11 is a diagram illustrating an exemplary process flow performed on the managed apparatus after transmitting the trap list 300 prepared by a series of processes in FIG. 9 to the managed apparatus.

When the trap list 300 is transmitted from the management apparatus 20 to the managed apparatus, the trap-list processing unit 52 in the managed apparatus receives the trap list 300 transmitted from the management apparatus 20 (S150). Then, the trap-list processing unit 52 creates the list of unreceived trap numbers from the information of unreceived trap numbers recorded on the received trap list 300 (S151).

Next, in loop 1 surrounded by the operations S152 and S155, the processes in the operations 153 and S154 are performed on the sequence numbers from the head to the last of the list of unreceived trap numbers, which is prepared in the operation S151. Specifically, for each received trap number, trap information corresponding to the unreceived trap number is extracted from the transmitted trap DB 54 (S153). Then, the extracted trap information is retransmitted to the manage apparatus 20 by the SNMP processing unit 50 (S154).

For all the sequence numbers included in the unreceived trap number prepared in the operation S151, after retransmitting the corresponding trap to the management apparatus 20, it is determined whether there is a need of retransmitting a series of traps including the last trap transmitted from the managed device (S156 to S162).

Specifically, the sequence number of the last trap included in the trap list 300 is set to the variable “LastNo” (S156). In addition, the sequence number of the last trap transmitted by the managed apparatus is set to the variable “SendNo” (S157). Then, the sequence numbers set to these variables “LastNo” and “SendNo” are compared with each other (S158). When the comparison results in the above values match each other (YES in S158), it means that the last trap transmitted to the managed apparatus has reached the managed apparatus. Therefore, the series of the operations in FIG. 11 is completed.

When the comparison in the operation S158 results in a mismatch (NO in S158), it is considered that the series of traps including the last trap transmitted from the managed apparatus may have not reached the management apparatus 20. Thus, undelivered traps are retransmitted by the procedures in the operations S159 to S162. In other words, in loop 2 surrounded by the operations S159 and S162, the loop variable “k” is incremented by “1” from “LastNo+1” to “SendNo” in order while the procedures in the operations S160 and S161 are performed. Specifically, for the trap corresponding to the sequence number represented by the variable “k”, trap information is extracted from the transmitted trap DB 54 (S160) and then retransmitted to the management apparatus (S161).

When the value of the loop variable “k” in loop 2 matches “SendNo” in the operation S162, transmission of all the traps to be retransmitted is completed. Thus, the series of the operations in FIG. 11 is completed.

Accordingly, an embodiment includes generating, at predetermined intervals, a list containing trap information received from each corresponding managed apparatus and determining whether information of a trap needs to be retransmitted based on a search of a trap omission from the list.

The functions and configurations of the management apparatus and the managed apparatus, which have been described above, are able to prevent the omission of SNMP traps transmitted through the communication network without placing loads on the communication network. Furthermore, in the case of increasing the number of the managed apparatuses, it is possible to reduce the processing load on the management apparatus.

Furthermore, the management apparatus and the managed apparatus each includes a CPU, a memory, a storage device, a communication network interface circuit, and so on. The process, which is represented by each flow in FIG. 7 to FIG. 11 as described above, is executed by the CPU in the management apparatus and the managed apparatus. Furthermore, each of these processes may be performed by a hardware circuit instead of the CPU in the management apparatus and the managed apparatus.

The received trap information 200, the trap list 300, the transmitted trap information 400, and the program for executing each process, which are described above, may be stored in the storage device, the memory, or the like in the management apparatus and the managed apparatus and executed by the CPU in each of these apparatuses. These pieces of information and programs may be stored in a computer-readable recording medium.

As such, the embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc—Read Only Memory), and a CD-R (Recordable)/RW. An example of communication media includes a carrier-wave signal.

Further, according to an aspect of the embodiments, any combinations of the described features, functions and/or operations can be provided.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has(have) been described in detail, it should be understood that the various changes, substitutions, and alterations could be made hereto without departing from the spirit and scope of the invention, the scope of which is defined in the claims and their equivalents.

What is claimed is:

1. A system, comprising:
a first apparatus including:
a first transmitting unit to transmit trap information provided with a sequence number to a second apparatus; and
a first storage unit to store the trap information; and
the second apparatus including:
a second storage unit to store the trap information received from the first apparatus,
a processing unit to create information indicating a missing sequence number and a sequence number of a last trap information received from the first apparatus, and
a second transmitting unit to transmit the information to the first apparatus, and
wherein the first apparatus includes a trap-list processing unit to determine whether trap information to be retransmitted is present based on the trap information stored in the first storage unit and the information received from the second apparatus, and retransmit the trap information to the second apparatus.

2. The system according to claim 1, wherein the processing unit creates the information for every fixed period.

3. The system according to claim 1, wherein the processing unit creates the information by determining whether a sequence number is missing with respect to trap information having sequence number that is not smaller than a sequence number of a minimum unreceived trap number of the first apparatus, where a minimum unreceived trap number is the minimum sequence number among missing sequence numbers of trap information.

4. The system according to claim 3, wherein the processing unit of the second apparatus sets a minimum unreceived trap number among missing sequence numbers in the information created for every first apparatus, as a new minimum unreceived trap number with respect to the second apparatus corresponding to the information.

5. The system according to claim 3, wherein the processing unit of the second apparatus sets a sequence number that follows a largest sequence number among the sequence numbers of the trap information received from the first apparatus as a new minimum received trap number with respect to the first apparatus corresponding to the information, when there is no unreceived trap number in the information.

6. A management apparatus for managing a managed apparatus, comprising:
a storage unit to store trap information received from the managed apparatus;
a processing unit to create information indicating a missing sequence number and a sequence number of a last trap information received from the managed apparatus, and a transmitting unit to transmit the information to the corresponding managed apparatus, and
wherein the management apparatus causes the managed apparatus to determine whether the trap information needs to be retransmitted, with reference to the information transmitted by the transmitting unit for every managed apparatus, and causes the managed apparatus to retransmit the trap information, which is to be transmitted, to the managed apparatus.

7. A managed apparatus, which is managed by a management apparatus and transmits trap information to the management apparatus, comprising:
a transmitting unit to transmit trap information provided with a sequence number to the management apparatus;
a storage unit to store the trap information; and
a trap-list processing unit to receive, from the management apparatus, information indicating a missing sequence number and a sequence number of a last trap information received from the managed apparatus by the management apparatus, determine whether trap information is to be retransmitted based on the trap information stored in the storage unit and the information received from the management apparatus, and retransmit trap information that is to be retransmitted to the management apparatus.

8. A method, comprising:
causing a first apparatus to transmit trap information provided with a sequence number to a second apparatus, and to store the trap information in a first storage unit;
causing the second apparatus to store the trap information received from the first apparatus in a second storage unit, and to create information indicating a missing sequence number and a sequence number of a last trap information received from the first apparatus; and
causing the first apparatus, which receives the information transmitted from the second apparatus, to determine whether trap information is to be retransmitted based on the trap information stored in the first storage unit and the information received from the second apparatus, and causing the first apparatus to retransmit the trap information, which is to be retransmitted, to the second apparatus.
